(19) United States
(12) Patent Application Publication
(10) Pub. No.: US 2026/0255326 A1
(43) Pub. Date: Aug. 27, 2026

(54) METHOD FOR OPERATING A RADIO NETWORK, AND A TRANSMITTER AND A RECEIVER

(71) Applicants: Fraunhofer Gesellschaft zur Förderung der angewandten Forschung e. V., München (DE); Diehl Metering GmbH, Ansbach (DE)

(72) Inventors: Hristo Petkov, Nürnberg (DE); Thomas Kauppert, Nürnberg (DE); Klaus Gottschalk, Winkelhaid (DE); Raimund Meyer, Fürth (DE); Frank Obernosterer, Nürnberg (DE); Jakob Kneissl, Fürth (DE); Josef Bernhard, Nabburg (DE); Gerd Kilian, Erlangen (DE)

(21) Appl. No.: 19/645,502

(22) Filed: Apr. 13, 2026

Related U.S. Application Data
(63) Continuation of application No. PCT/EP2024/077271, filed on Sep. 27, 2024.

(30) Foreign Application Priority Data
Oct. 13, 2023 (DE) 10 2023 128 098.8

(51) Int. Cl. H04W 72/044

(52) U.S. Cl. CPC H04W 72/044

(57) ABSTRACT

A method operates a radio network in which a message in the form of a data packet is split, in a telegram splitting method, into individual sub-data packets by a transmitter of the radio node in the uplink, and the sub-data packets are sent in the uplink as one radio burst each, in succession, in a hopping pattern to the receiver. The sub-data packets of the hopping pattern are sub-data packets of a frame each containing a pilot sequence. The hopping pattern is a time and/or a frequency hopping pattern. To be able to use energy buffers more easily, the hopping pattern is configured such that the frame or the total number of radio bursts of the frame is greater than the coherence time, and the frequency and/or time of the radio bursts of the frame is adjusted in a receiver based on the frequency and/or time hypotheses.

### CROSS-REFERENCE TO RELATED APPLICATION

This application is a continuation, under 35 U.S.C. § 120, of copending International Patent Application PCT/EP2024/077271, filed Sep. 27, 2024, which designated the United States; this application also claims the priority, under 35 U.S.C. § 119, of German Patent Application DE 10 2023 128 098.8, filed Oct. 13, 2023; the prior applications are herewith incorporated by reference in their entireties.

### FIELD AND BACKGROUND OF THE INVENTION

The present invention relates to a method for operating a radio network, preferably a radio network of the TS (telegram splitting) narrowband family. Furthermore, the present invention relates to a transmitter of a radio node and to a receiver, each of which are operated in accordance with the method in the radio network.

The invention is aimed at a radio network as described, for example, in the ETSI TS 103 357 V1.1.1 (2018/06) standard. This is a radio network that uses license-free frequency bands. In such networks, a large number of radio nodes, in particular end nodes, are provided, which communicate with receiving radio nodes, for example so-called base stations or gateways, via radio either only on the uplink or on both the uplink and downlink. A radio node may be a sensor device for acquiring data of any kind, an actuator device for performing certain actions or measures, or a combination of a sensor device and an actuator device. Such radio nodes are operated with a dedicated, i.e. autonomous, power supply in the form of a non-rechargeable hard-wired long-life battery, which has a limited service life dependent on the individual energy consumption of the node and is not rechargeable, but must be replaced at the end of its service life. Under normal circumstances, such a battery can be used to achieve a service life of at least ten years “in the field” until replacement becomes necessary.

To send messages or data packets (telegrams) through the radio node, energy from the battery must be kept in an energy buffer so that the energy consumer (e.g. the transmitter module or transceiver module of the radio node) can obtain the necessary energy for transmission. To send a telegram or a data packet, the latter is broken down into individual sub-data packets, wherein the individual sub-data packets are then transmitted in hopping patterns, which comprise time and/or frequency hopping patterns, as radio bursts in the uplink. For this purpose, the data packet is divided into a so-called core frame and an extension frame, where both the core frame and the extension frame are in turn divided into individual sub-data packets. Each sub-data packet of the core frame contains a pilot sequence that is used to synchronize with the receiver. To be able to successfully decode a data packet, it is necessary that the hopping pattern that was used for sending it is known to the recipient.

Conventional hopping patterns for sub-data packets or radio bursts of the core frame pose a challenge to the energy buffer of the transmitting radio node, since a certain voltage threshold must not be undershot during the discharge of the energy buffer occurring at short intervals. For this reason, it has previously been necessary to use expensive hybrid layer capacitors (HLC) as energy buffers. There is therefore a continuing need to be able to use less expensive electrolytic capacitors for such methods for operating a radio node.

### DOCUMENTED PRIOR ART

International patent disclosure WO 2018/188814 A2, corresponding to U.S. Pat. No. 11,742,893, has already disclosed the use of individual hopping patterns for a telegram splitting method. The individual hopping pattern proposed there depends on an operating parameter of the data transmitter in question. In this case, successive radio bursts can also be combined into a cluster.

European patent EP 3 649 758 B1, corresponding to U.S. Pat. No. 11,258,477 B2, describes a data transmitter which is configured to transmit data in a first mode using a first hopping pattern and repeat the process using a second hopping pattern. Furthermore, the data transmitter is configured to transmit data once in a second mode using a third hopping pattern, the hopping patterns of the first mode and the second mode being different. The data transmitter in this case is designed to select the first hopping pattern and the second hopping pattern from a set of hopping patterns, and to select the third hopping pattern from a second set of hopping patterns. Time and frequency coherence exists between emissions of the first and second hopping patterns.

Published, non-prosecuted German patent application DE 10 2022 101 405 A1, corresponding to U.S. patent disclosure No. 2024/0163789, describes a method for operating a node in a radio network in which extended pauses ΔT_add are inserted between clusters of radio bursts of a hopping pattern. According to an alternative, the pauses can also be selected in such a way that they lie outside the coherence time.

### SUMMARY OF THE INVENTION

The object of the present invention is to improve the generic method in such a way that cheaper energy buffers can be used for radio nodes.

The above object is achieved by the method as claimed in the first independent method claim and as claimed in the subordinate independent claims. Advantageous embodiments are specified in dependent claims. With respect to the transmitter or receiver of the radio network, the object is achieved by the dependent claims.

Because the hopping pattern is configured in such a way that the frame or the total number of radio bursts of the frame (e.g. core frames with 24 radio bursts) is greater than the coherence time and because the frequency and/or time are readjusted in the receiver based on frequency and/or time hypotheses, the receiver can maximize the synchronization based on the received energy of the pilot sequences of the radio bursts. Frequency and/or time hypotheses contain an assumption that the time error or frequency error of the time reference or frequency reference device (time crystal or radio crystal) of the radio node is represented as a time/frequency shift of the radio burst of a frame. By taking into account the frequency and/or time hypotheses, hopping patterns that do not lie within the coherence time can be used. Such hopping patterns, in turn, enable effective relief of the load on the energy buffer of a radio node. This means that much cheaper energy buffers can be used. On the other hand, with minimal cost in the form of an only slight increase in computing power, it is possible to guarantee sufficient reception of a message or data packet that can actually no longer be received in the Telegram splitting method.

The coherence time is a quarter (0.25) of the symbol duration divided by the permissible timing error of the time reference device on the transmitter side. According to one embodiment of the invention, the coherence time can be 5.25 s. This coherence time is derived from a maximum permissible timing error of the transmitter-side time reference device (“quartz crystal error”) of 20 ppm at 105.0256 μs (one quarter of the symbol duration in the UL of e.g. 2380.371 sym/s).

Preferably, the frequency and/or time hypotheses are derived on a rising and/or falling frequency of the timer crystal or the frequency crystal of the radio node. A timer crystal and frequency crystal of a radio node can be realized by two separate individual quartz crystals or by a single crystal.

According to one embodiment of the invention, only a subset of the total set of hypothetically possible frequency and/or time shifts is used for the readjustment.

According to one embodiment of the invention, only a subset (for example, a subset combined into a block) of the total set of radio bursts of a frame, preferably at least one second subset temporally following a first subset, can be used when readjusted. This can save computing time and thus energy.

According to one embodiment of the invention, the total set of radio bursts of the frame can be divided into a plurality of blocks and a readjustment with respect to frequency and/or time can be carried out block-by-block. For example, the 24 radio bursts of the frame can be divided into two blocks of 12 radio bursts each, or into three blocks of 8 radio bursts each, depending on how much the frame duration exceeds the coherence time. Preferably, for the readjustment, the total number of radio bursts of the frame can be divided into individual blocks (e.g. 24 radio bursts into 3 blocks of 8 radio bursts each).

Preferably, to readjust the time for a block, no shift, a shift by +T/x or a shift by −T/x can be carried out, where T is the symbol duration and x is a preferably integer natural number.

Alternatively or additionally, to readjust the frequency for a block, no shift, an increase in the frequency +yF or a reduction in the frequency −yF can be carried out, where F is the frequency and y is a preferably integer natural number.

According to one embodiment of the invention, to readjust the time, the first block may not be shifted, the second block may be shifted by +T/x or −T/x, and the third block (B3) may be shifted by +T/x or −T/x, where T is the symbol duration and x is a preferably integer natural number. Alternatively or additionally, to perform a readjustment, the frequency of the frequency of the first block may not be shifted, for the second block the frequency may be shifted by +yF or −yF, and for the third block (B3) the frequency may be shifted by +yF or −yF, where F is the frequency and y is a preferably integer natural number. The product of the possible time and frequency shifts represents the maximum number of possibilities for the total number of radio bursts of the frame.

According to one embodiment of the invention, the amount of readjustment as a time shift of a block (for example, the second of three blocks) relative to a subsequent block (for example, the third of three blocks) can be between 0 and T/4, where T is the symbol duration. Alternatively or additionally, the readjustment as a frequency shift between two subsequent blocks (e.g. the first and second of three blocks) can be between 0 and 10 Hz.

According to a further embodiment, also specified in a subordinate claim, with a total number of 24 radio bursts of the frame in the hopping pattern, three radio bursts are each combined into a cluster, the time spacing between the radio bursts of the respective cluster being dimensioned such that the frame or the total number of radio bursts of the frame is greater than the coherence time. Alternatively, no clusters are formed, so that the time spacing between the radio bursts is dimensioned such that the frame or the total number of radio bursts of the frame is greater than the coherence time. A “cluster” is defined as an arrangement of a plurality of adjacent radio bursts in a hopping pattern that has equal time spacings between the bursts.

According to one embodiment of the invention, the time spacing between the first and second radio burst of the respective cluster comprising three radio burst can be in a range of 1483 symbol lengths±20%, and the time spacing can preferably be 1483 symbol lengths. Furthermore, the time spacing between the second and third radio burst of the respective cluster can be in a range of 1683 symbol lengths±20%, and the time spacing can preferably be 1683 symbol lengths.

According to an embodiment of the invention, which is also specified in a subordinate claim, the time hopping patterns defined in the third independent claim can be used.

Advantageously, a symbol contains a symbol duration of 1/(K*2380.371), where K is an integer number. The deviation is preferably +20%. In particular, a symbol duration of 420.10 μs is provided.

According to one embodiment of the invention, the frequency hopping patterns can be used consistently in different frequency hopping patterns. The frequency hopping patterns correspond to the frequency hopping patterns defined in ETSI TS103 357 V1.1.1 (2018 June), so that the different time hopping patterns are as orthogonal as possible to each other due to the identical frequency hopping pattern. This results in less overlap of the radio bursts of a hopping pattern (time hopping pattern) according to the invention and the radio bursts of the time hopping pattern in the ETSI TS103 357 V1.1.1 (2018 June) standard. This results in fewer disruptions.

According to one embodiment of the invention, also specified in a subordinate claim, all radio bursts of the frame can have an identical time spacing between one another, and/or the time spacing between two adjacent radio bursts can be in a range from 0.567 s to 0.757 s, and/or the duration of the frame can be in a range from 14.96 s to 15.32 s. In these ranges, a readjustment can be successfully completed in the receiver.

According to one embodiment of the invention, the receiver can preferably simultaneously search for a hopping pattern of which the frame or the total number of radio bursts of the frame is greater than, i.e. outside, the coherence time, and for a hopping pattern of which the frame or the total number of radio bursts of the frame is within the coherence time. This allows radio nodes with energy buffers of different performance to be operated in a common radio network.

According to one embodiment of the invention, the receiver can determine the frequency of occurrence or reception of the respective hopping pattern as part of a statistical data collection. Preferably, the receiver can adapt its search behavior based on the determined frequency of the respective hopping pattern, for example, by intensifying its search for hopping patterns, of which the frame or the total number of radio bursts of the frame are greater than the coherence time.

According to one embodiment of the invention, the transmitter of the radio node in the uplink can transmit an energy buffer-relevant message (high-quality energy buffer or low-quality energy buffer) to the receiver, whereupon the receiver specifies the search for the relevant coherent or non-coherent hopping pattern.

The present invention further relates to a transmitter and receiver for operating a radio network, preferably a radio network of the TS (Telegram Splitting)—narrow band family, which are configured to be operated according to the method claims.

Other features which are considered as characteristic for the invention are set forth in the appended claims.

Although the invention is illustrated and described herein as embodied in a method for operating a radio network, and a transmitter and receiver, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a block diagram of a radio network, preferably an SRD radio network, for applying a method according to the present invention;

FIG. 2 is a highly simplified block diagram of an example of functional elements comprised by a node of the radio network;

FIG. 3 is a schematic of a circuit configuration of an energy buffer of the node according to FIG. 2;

FIG. 4 is an exemplary graph of both a current drawn and an operating voltage curve of the energy buffer of the node against time when a data packet is transmitted in an uplink and downlink;

FIG. 5 is an illustration showing an example of a formation of radio bursts of individual sub-data packets of a data packet in the uplink;

FIG. 6 is an illustration showing an example of a frequency-time hopping pattern for sending radio bursts;

FIG. 7 is an illustration showing a structure of an individual radio burst;

FIG. 8 is an illustration showing a first example of a readjustment of the radio bursts in a receiver according to the present invention;

FIG. 9 is an illustration showing a further example of a readjustment of the radio bursts in the receiver according to the present invention;

FIG. 10. is a block diagram showing a highly simplified representation of a network according to the invention with a receiver capable of searching for different hopping patterns in relation to the loading of the energy buffer; and

FIG. 11 is an illustration showing a highly simplified representation of a network according to the invention with a hopping pattern forming clusters of three adjacent radio bursts each.

### DETAILED DESCRIPTION OF THE INVENTION

Examples of advantageous embodiments of the present invention will now be explained in more detail by reference to the figures of the drawing.

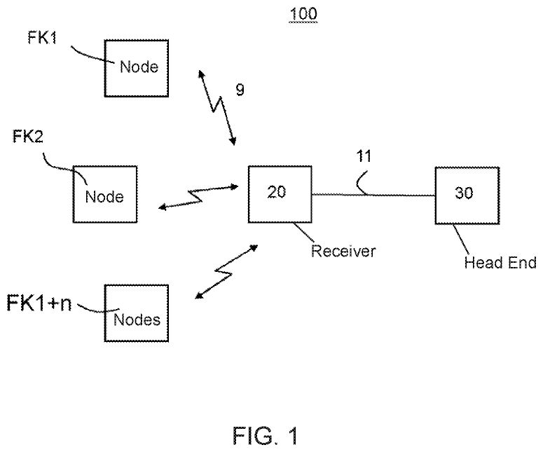

Referring now to the figures of the drawings in detail and first, particularly to FIG. 1 thereof, there is shown a radio network 100, preferably of the kind as defined in the ETSI TS 103 357 V1.1.1 (2018 June) standard. It comprises a plurality of individual autonomously powered radio nodes FK1-FK1+n and a receiver 20. The radio nodes FK1-FK1+n are in particular sensor devices, actuators or combinations thereof for use in the so-called IoT. In this arrangement, data from the individual radio nodes FK1-FK1+n is transmitted by means of radio transmission 9 to the receiver 20 (uplink) and/or data is transmitted from the receiver 20 by means of radio transmission 9 to the individual radio nodes FK1-FK1+n (downlink). The individual radio nodes FK1-FK1+n are in the sending or receiving range of the respective receiver 20.

The radio nodes FK1-FK1+n can be, for example, water, gas, electricity or energy meters. The receiver 20 can be a base station, a data collector, a gateway or another radio node.

The data of the radio nodes FK1-FK1+n received by the receiver 20 can then be transmitted via a suitable data transmission means 11 to a headend 30 or to a data center. The data transmission means 11 can be, for example, a cellular connection or an internet connection or a combination of these. The data transmission of the radio transmission 9 takes place by telegram splitting in the narrow band, preferably in the ultra-narrow band, particularly preferably in the context of so-called telegram splitting (TS-UMB family). The uplink usually primarily relates to the transmission of user data generated in the individual radio nodes FK1-FK1+n as well as operating data (e.g. pilot sequences) of the individual nodes. The data provided by the headend 30 for the receiver 20 via the data transmission means 11 and transmitted on to the radio nodes FK1-FK1+n by radio transmission 9 in the downlink is primarily configuration data, data for the operating system of the individual nodes, software updates, etc.

FIG. 2 shows the exemplary structure of a node FK1-FK1+n for use in the method according to the invention. The radio node FK1 contains a microprocessor 14, a transmitter 10 or transceiver, and an antenna 17 for transmitting or receiving radio signals of the radio transmission 9. Furthermore, the node FK1-FK1+n contains a memory 15, a battery 12 and an energy buffer 13. The battery 12 is preferably a so-called long-life battery, that is, a non-rechargeable battery, which supplies the node FK1 with energy over the entire usage cycle of the latter until it has to be replaced. Such long-life batteries have a lifetime of more than 10 years, assuming normal energy consumption of the node FK1. The power for the microprocessor 14 or transmitter 10 or transceiver or the memory 15 is supplied via an energy buffer 13 upstream of the battery 12, which is discharged accordingly in the event of an energy demand and is then recharged from the battery. The aforementioned components of the node FK1 such as, for example, the microprocessor 14, the transmitter 10 or transceiver, the antenna 17 and/or the memory 15 may also be combined in assembly components.

Reference sign 16 refers to a time reference device in the form of a quartz crystal, which is preferably both provided as a time measurement device, i.e. serving as a time reference, and used for generating the carrier signal. The receiver 20 or the base station is likewise equipped with a quartz crystal (not shown in the figures), which generates the clock for the carrier signal for the carrier frequency of the radio signal sent by the receiver 20 and is responsible for the time measurement there. The two crystals differ with regard to their accuracy. The crystal of the receiver 20 has an accuracy of approx. 2 ppm, whereas the crystal 16 has to have an accuracy of only approx. 20 ppm by specification.

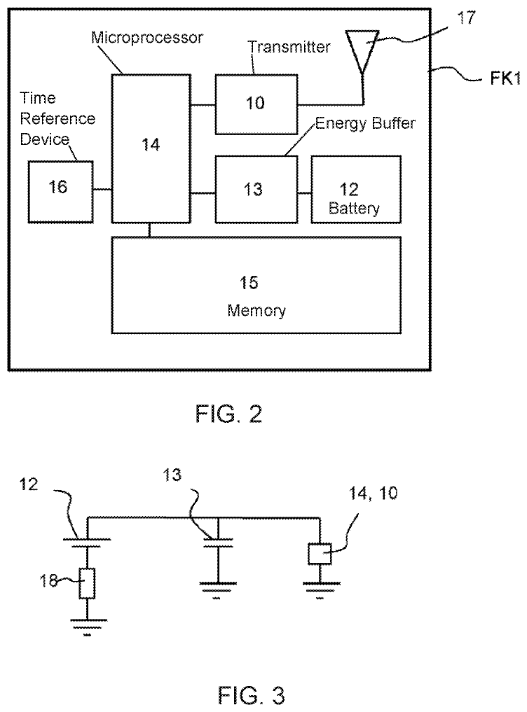

As can be seen from FIG. 3, the battery 12 has a certain internal resistance 18. The microprocessor 14 and the transmitter 10 or transceiver form the “consumers” of the energy stored in the energy buffer 13. If the energy stored in the energy buffer 13 is consumed by the microprocessor 14 or transmitter 10 or transceiver, for example, because a data packet (telegram) is sent, the energy buffer 13 is discharged for a certain time until it is recharged by the battery 12. This causes a voltage drop in the energy buffer 13. The voltage drop depends on the energy required by the consumer. The voltage drop and the recharging of the energy buffer 13 are shown below using an example:

$${U}_{t 2} = {U}_{t 1} - \frac{I {t}_{on}}{C} . \qquad ( 1 )$$

An initial voltage Uₜ₁=3.6V, a current pulse of tₒₙ=10 ms, a current of I=20 mA and a capacitor of C=860 μF result in a new voltage of Uₜ₂=3.367 V. After the “consumer” has finished drawing the current, the energy buffer 13 is slowly charged from the battery 12.

$${U}_{t 3} = {U}_{battery} - ( {U}_{battery} - {U}_{t 2} ) {e}^{- \frac{{t}_{off}}{R C}} . \qquad ( 2 )$$

An initial voltage Uₜ₁=3.367V, a recovery period of t_{off}=150 ms, an internal resistance of the battery of R=1000Ω and a capacitor of C=860 μF result in a new voltage of Uₜ₃=3.404 V.

The electronics of node FK1 requires a stable voltage of the energy buffer 13 in order for it to function. A stable voltage is understood to mean a minimum voltage or a voltage threshold that must not be undershot during operation. For example, the minimum voltage for a conventional radio node is in the range of 2.7 to 3.0 V.

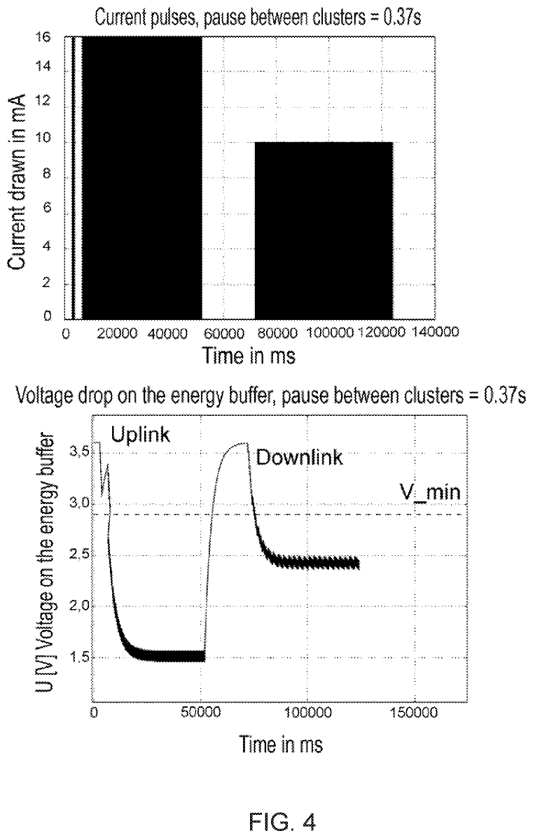

For better understanding the upper illustration of FIG. 4 shows on the left an example of a current profile for the transmission of a telegram in the uplink in the conventional telegram splitting method and on the right a current profile in the downlink for the reception of all sub-data packets by the node, also in the conventional telegram splitting method. Telegram splitting method means that a data packet (message or telegram) is divided into individual sub-data packets and the sub-data packets are each sent in succession as a radio burst FB, received by the receiver 20 and recombined again to form the information about the data packet. The time spacing T_RB for the continuously repeated transmission of the sub-data packets is usually on average approx. 150 ms in the uplink and approx. 220 ms in the downlink. In FIG. 4 top left, therefore, 24 current pulses at the indicated level have been drawn from the energy buffer 13 over the indicated time.

The sub-data packets can usually be sent over a single frequency channel, or alternatively, individually over multiple different frequencies or frequency channels in the so-called frequency hopping procedure.

As can be seen from FIG. 4, the energy buffer 13 in the conventional method is strongly discharged by the sending of the data packets in the uplink until it is charged again above the operating voltage threshold V_min at approx. 2.9 V due to the charging by the battery 12 over the period of a pause of 0.37 s. When a data packet is received by the receiver of the node in the downlink, the energy buffer 13 is strongly discharged again. Subsequently, it is recharged again, which is not shown in the upper illustration of FIG. 4. It can be seen that the energy buffer 13 is below the operating voltage threshold V_min line for a considerable period of time during the uplink and downlink. Up to now, so-called Hybrid Layer Capacitors (HLC) have been commonly used to prevent excessive discharge. HLCs are expensive.

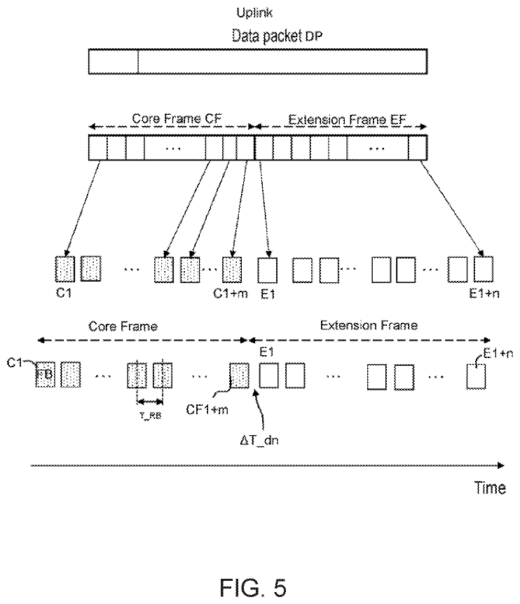

FIG. 5 shows a section of the so-called telegram splitting method, in which, for example, according to ETSI TS103 357 V1.1.1 (2018 June), a data packet DP, which is intended for sending in the uplink by the respective radio node FK1-FK1+n, is divided, i.e. “split”, into individual sub-data packets C1 to C1+m, E1 to E1+n. For the transmission of the data packet DP, this is initially divided into a frame in the form of a so-called core frame CF and a further frame in the form of a so-called extension frame EF, wherein the extension frame EF usually contains at least substantially user data and the core frame CF contains at least substantially signaling or control information, in particular the so-called pilot sequence. For transmission, the data of the extension frame EF is divided into individual sub-data packets E1 to E1+n. Likewise, in the uplink, the data of the core frame CF is divided into sub-data packets C1 to C1+m, as shown in FIG. 5.

Adjacent radio bursts are separated by a time interval T_RB, as shown in FIG. 5 for the example of two radio bursts FB of the core frame.

The pause between the core frame and extension frame is defined as ΔT_si in the ETSI TS 103 357 V1.1.1 (2018 June) standard. In conventional radio systems, a block B in the downlink consists, for example, of 18 radio bursts or sub-data packets E1-E18. A block pause ΔT_dn is conventionally provided between the respective blocks. In the ETSI TS103 357 V1.1.1 (2018 June) radio standard, this block pause may last for a maximum of 7,168 symbols, based on a symbol rate of 2,380,371 sym/s. This corresponds to a time value of 3.011 seconds.

A block B in the uplink conventionally consists e.g. of 24 radio bursts or sub-data packets E1-E24.

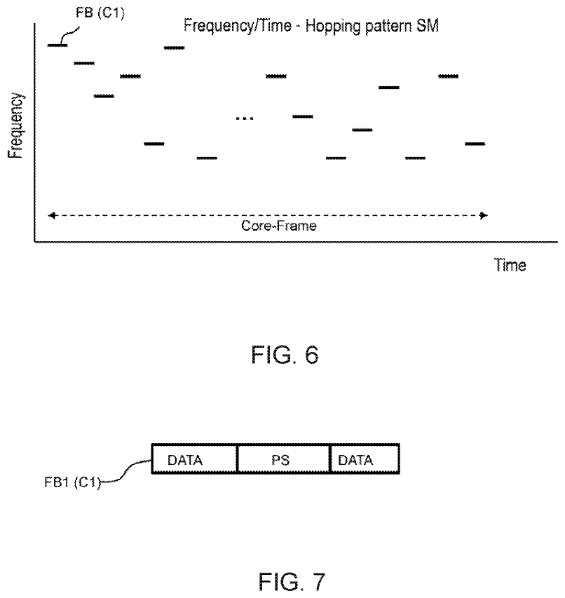

Conventional hopping patterns, such as that of ETSI TS103 357 V1.1.1 (2018 June), make it necessary to use high-quality and therefore expensive energy buffers 13. A frequency/time hopping pattern normally used in the telegram splitting method is shown schematically in FIG. 6 as hopping pattern SMK. In this pattern, the sub-data packets C1-C1+m of the core frame CF are transmitted from the transmitter 10 to the receiver 20 according to a specified frequency/time hopping pattern in the form of radio bursts FB transmitted sequentially and with different carrier frequencies. The transmission takes place within the coherence time. In the hopping pattern SM shown in FIG. 6, the message frames a total of 24 radio bursts FB.

FIG. 7 shows an example of the structuring of a radio burst FB (C1). A radio burst FB of the core frame CF contains two data sequences and a pilot sequence PS, which is used for synchronization. The pilot sequence PS consists of 12 bits.

In order to protect the energy buffer 13 of a radio node FK1-FK1+n, according to the present invention, the use of a hopping pattern SM is proposed which lies outside the coherence time. The coherence time is the time in which a radio burst FB of a transmission can still be used by the receiver 20 without the frequency or time needing to be readjusted. The coherence time is defined by specifying a maximum time error in the form of a fraction of the symbol duration (e.g. 0.25). The coherence time t (UL) depends on the frequency accuracy of the crystal and can be represented as follows:

$$t ( UL ) = \frac{105.0256 μ s}{20 ppm} = 5.25 s .$$

The 20 ppm corresponds to the specified frequency accuracy of the uplink signal sent by the radio node FK1-Fk1+n. The value 105.0256 μs is a quarter of the symbol duration in the UL (2380.371 sym/s).

The use of a hopping pattern which lies outside the coherence time means that in the receiver 20 a readjustment of the frequency and/or time must be carried out in order to ensure satisfactory reception. Such a readjustment is carried out according to the invention based on frequency and/or time hypotheses.

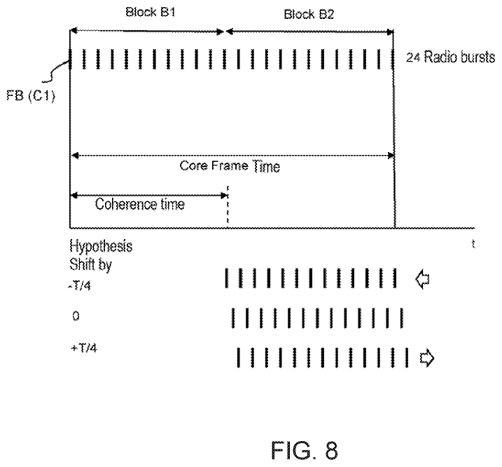

FIG. 8 shows an example of the transmission of 24 radio bursts FB, e.g. with the same time interval T_RB. The time intervals T_RB between adjacent radio bursts FB in this case are so large that the energy buffer 13 of the radio node Fk1-FK1+n is less heavily loaded, so that a cheaper energy buffer 13 can advantageously be used in this hopping pattern SM. As is clear from FIG. 8, the duration (e.g. 10 s) of the transmission of the 24 radio bursts FB is roughly twice as long as the coherence time (5.25 s).

In order to make a hypothesis, the entire duration of the core frame CF (e.g. 10 s) is divided by the coherence time (5.25 s) so that, for example, two blocks B1 and B2 are obtained. According to the invention, only the radio bursts FB of block B2, i.e. a subset of the total set of radio bursts FB, can now be readjusted. The radio bursts FB of block B2 are a subset of radio bursts FB, which chronologically follows the subset of the first block B1 of radio bursts FB. With regard to the readjustment, three hypotheses can be assumed, for example: the time has not yet elapsed, the time has elapsed in the minus direction and the time has elapsed in the plus direction. For this reason, in the receiver 20, the second half of the core frame CF, i.e. block B2, is either retained in the temporal position, shifted in the minus direction or shifted in the plus direction. Thus, the three hypotheses result in 3 possibilities, namely possibility 1, in which no shift takes place, possibility 2, in which a shift takes place counter to the time direction, e.g. by −T/4, and possibility 3, in which a shift takes place in the time direction, e.g. by +T/4. T is the symbol duration. According to ETSI TS103 357 V1.1.1 (2018 June) it is equal to 1/2380.317 s. Due to the described measure, the receiver, on account of the readjustments it has to perform based on the hypotheses described, is in the of maximizing the synchronization energy on the basis of the pilot sequences PS.

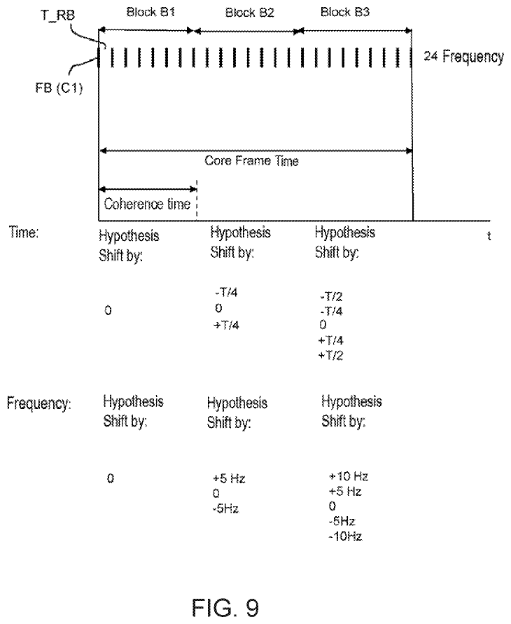

FIG. 9 shows a further variant of the method according to the invention, in which the radio bursts FB of the core frame CF are divided into three blocks B1, B2 and B3, for example, due to a duration of the core frame which corresponds approximately to three times the length of the coherence time. In this case, certain shifts with respect to the individual blocks B1, B2 and B3 are also defined. For example, with respect to block B1 it is specified that no shifting of the time or frequency should take place. With respect to the second block B2, in turn, three shifts are made for the time and frequency in each case, which comprise for the time 0, −T/4, +T/4 and for the frequency, for example, the hypotheses 0 Hz, +5 Hz, −5 Hz. With respect to the third block B3, further shifts, such as −T/2 and +T/2 or −10 Hz and +10 Hz, are added.

According to one aspect of the invention, not all possible shifts are used, but only a subset of them. Accordingly, for example, the following shifts {0, 0, 0}, {0, 0, T/4}, {0, 0, −T/4}, {0, T/4, T/4}, {0, T/4, T/2}, {0, −T/4, 0}, {0, −T/4, −T/4}, {0, −T/4, −T/2}, {0, T/4, 0}, {0, −T/4, 0} are used for the time and the following hypotheses {0, 0, T/2}, {0, 0, −T/2}, {0, T/4, −T/4}, {0, T/4, −T/2}, {0, −T/4, T/4}, {0, −T/4, T/2} are not used.

A corresponding procedure can also be used for a frequency readjustment. For this purpose, with a total number of 24 radio bursts (FB) of the core frame (CF) a division into 3 blocks (B1-B3) of 8 radio bursts each can also be carried out, wherein in this case the shifts {0, 0, 0}, {0, 0, 5 Hz}, {0, 0, −5 Hz} {0, 5 Hz, 5 Hz}, {0, 5 Hz, 10 Hz} {0, −5 Hz, 0}, {0, −5 Hz, −5 Hz}, {0, −5 Hz, −10 Hz}, {0, 5 Hz, 0} are preferably used and the shifts {0, 0, 10 Hz}, {0, 0, −10 Hz}, {0, 5 Hz, 0}, {0, 5 Hz, −5 Hz}, {0, 5 Hz, −10 Hz}, {0, −5 Hz, 5 Hz}, {0, −5 Hz, 10 Hz} are not used.

The invention makes it possible to enable an effective search for hopping patterns SM which lie outside the coherence time, in the receiver 20 with manageable computational effort.

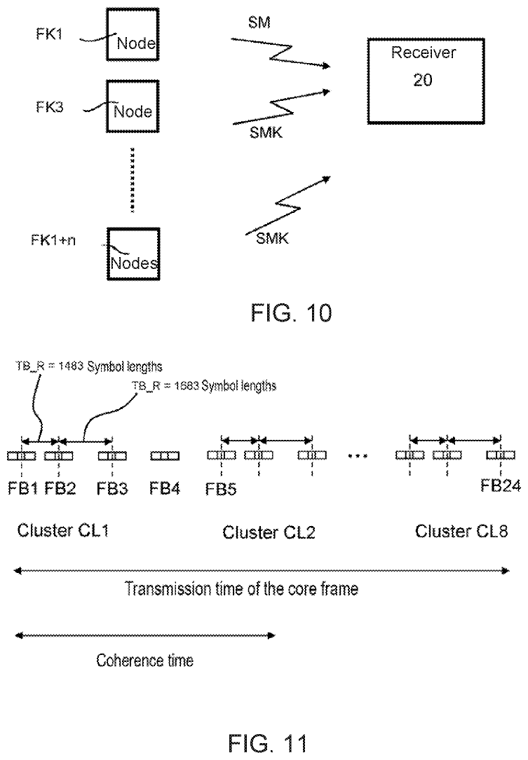

As schematically illustrated in FIG. 10, a radio network of the TS (telegram-splitting) narrow band family can be operated with a plurality of radio nodes FK1-FK1+n, wherein certain radio nodes, e.g. the radio nodes FK3 and FK1+n, transmit the core frame CF via a hopping pattern SMK lying within the coherence time, whereas some radio nodes, for example the radio node FK1, transmits a hopping pattern SM that is outside the coherence time. The receiver 20 is able to search for the different hopping patterns SM and SMK, preferably simultaneously, and to perform a synchronization.

A corresponding hopping pattern SM lying outside the coherence time can be configured in such a way that the time interval T_RB between the first and second radio burst (FB1, FB2) of the respective cluster (CL1-CL8) is in a range of 1483 symbol lengths±20%, or equal to 1483 symbol lengths, wherein the time interval T_RB between the second and third radio burst (FB2, FB3) of the respective cluster (CL) is in a range of 1683 symbol lengths±20%, or is equal to 1683 symbol lengths, see FIG. 11. The time intervals T_RB for the intervening radio bursts can vary.

Advantageously, hopping patterns SM (time hopping patterns) that do not correspond to the coherence requirement, which are defined by the following table, can be used as hopping patterns:

TABLE 1
non-coherent hopping patterns SM (time hopping patterns)

| SM | T_{RB}(S) | | | | | | | | | | | |
|---|---|---|---|---|---|---|---|---|---|---|---|---|
| No. | 1 | 2 | 3 | 4 | 5 | 6 | 7 | 8 | 9 | 10 | 11 | 12 |
| 1 | 1483 | 1683 | 1670 | 1483 | 1683 | 1146 | 1483 | 1683 | 1744 | 1483 | 1683 | 1644 |
| 2 | 1483 | 1683 | 1659 | 1483 | 1683 | 1681 | 1483 | 1683 | 1745 | 1483 | 1683 | 1464 |
| 3 | 1483 | 1683 | 1604 | 1483 | 1683 | 1756 | 1483 | 1683 | 1782 | 1483 | 1683 | 1697 |
| 4 | 1483 | 1683 | 1734 | 1483 | 1683 | 1519 | 1483 | 1683 | 1403 | 1483 | 1683 | 1397 |
| 5 | 1483 | 1683 | 1803 | 1483 | 1683 | 1473 | 1483 | 1683 | 1796 | 1483 | 1683 | 1464 |
| 6 | 1483 | 1683 | 1481 | 1483 | 1683 | 1528 | 1483 | 1683 | 1582 | 1483 | 1683 | 1511 |
| 7 | 1483 | 1683 | 1524 | 1483 | 1683 | 1555 | 1483 | 1683 | 1481 | 1483 | 1683 | 1350 |
| 8 | 1483 | 1683 | 1358 | 1483 | 1683 | 1546 | 1483 | 1683 | 1379 | 1483 | 1683 | 1680 |

| SM | T_{RB}(S) | | | | | | | | | | |
|---|---|---|---|---|---|---|---|---|---|---|---|
| No. | 13 | 14 | 15 | 16 | 17 | 18 | 19 | 20 | 21 | 22 | 23 |
| 1 | 1483 | 1683 | 1409 | 1483 | 1683 | 1444 | 1483 | 1683 | 1634 | 1483 | 1683 |
| 2 | 1483 | 1683 | 1753 | 1483 | 1683 | 1368 | 1483 | 1683 | 1439 | 1483 | 1683 |
| 3 | 1483 | 1683 | 1441 | 1483 | 1683 | 1450 | 1483 | 1683 | 1349 | 1483 | 1683 |
| 4 | 1483 | 1683 | 1571 | 1483 | 1683 | 1539 | 1483 | 1683 | 1350 | 1483 | 1683 |
| 5 | 1483 | 1683 | 1399 | 1483 | 1683 | 1491 | 1483 | 1683 | 1372 | 1483 | 1683 |
| 6 | 1483 | 1683 | 1645 | 1483 | 1683 | 1677 | 1483 | 1683 | 1605 | 1483 | 1683 |
| 7 | 1483 | 1683 | 1389 | 1483 | 1683 | 1754 | 1483 | 1683 | 1762 | 1483 | 1683 |

wherein each time hopping pattern contains 23 hops, wherein each entry in the table indicates a time interval T_RB(s) from a reference point of the respective radio burst to an equal reference point of a directly following radio burst in symbols (e.g. symbols with a symbol duration of 1/2380.371 s per symbol), where in the table each row of rows 1-8 is a time hopping pattern.

Preferably, in combination with the above hopping pattern SM, frequency hopping patterns are used which are defined by the following table:

TABLE 2
uniform frequency hopping patterns for SM and SMK

| SM | C_{RB}(S) | | | | | | | | | | | | |
|---|---|---|---|---|---|---|---|---|---|---|---|---|---|
| No. | 0 | 1 | 2 | 3 | 4 | 5 | 6 | 7 | 8 | 9 | 10 | 11 | 12 |
| 1 | 5 | 21 | 13 | 6 | 22 | 14 | 1 | 17 | 9 | 0 | 16 | 8 | 7 |
| 2 | 4 | 20 | 12 | 1 | 17 | 9 | 0 | 16 | 8 | 6 | 22 | 14 | 7 |
| 3 | 4 | 20 | 12 | 3 | 19 | 11 | 6 | 22 | 14 | 7 | 23 | 15 | 0 |
| 4 | 6 | 22 | 14 | 2 | 18 | 10 | 7 | 23 | 15 | 0 | 16 | 8 | 1 |
| 5 | 7 | 2 | 15 | 4 | 20 | 12 | 3 | 19 | 11 | 2 | 18 | 10 | 6 |
| 6 | 3 | 19 | 11 | 6 | 22 | 14 | 2 | 18 | 10 | 0 | 16 | 8 | 7 |
| 7 | 3 | 19 | 11 | 1 | 17 | 9 | 5 | 21 | 13 | 7 | 23 | 15 | 0 |
| 8 | 0 | 16 | 8 | 6 | 22 | 14 | 3 | 19 | 11 | 2 | 18 | 10 | 4 |

| SM | C_{RB}(S) | | | | | | | | | | |
|---|---|---|---|---|---|---|---|---|---|---|---|
| No. | 13 | 14 | 15 | 16 | 17 | 18 | 19 | 20 | 21 | 22 | 23 |
| 1 | 23 | 15 | 4 | 20 | 12 | 3 | 19 | 11 | 2 | 18 | 10 |
| 2 | 23 | 15 | 2 | 18 | 10 | 5 | 21 | 13 | 3 | 19 | 11 |
| 3 | 16 | 8 | 5 | 21 | 13 | 2 | 18 | 10 | 1 | 17 | 9 |
| 4 | 17 | 9 | 4 | 20 | 12 | 5 | 21 | 13 | 3 | 19 | 11 |
| 5 | 22 | 14 | 0 | 16 | 8 | 1 | 17 | 9 | 5 | 21 | 13 |
| 6 | 23 | 15 | 1 | 17 | 9 | 4 | 20 | 12 | 5 | 21 | 13 |
| 7 | 16 | 8 | 2 | 18 | 10 | 6 | 22 | 14 | 4 | 20 | 12 |
| 8 | 20 | 12 | 7 | 23 | 15 | 5 | 21 | 13 | 1 | 17 | 9 |

wherein each frequency hopping pattern contains 24 hops, wherein in the table each entry is a transmit frequency CRB(S) or a frequency channel of the frequency hopping pattern, wherein in the table each row of rows 1-8 is a frequency hopping pattern, and wherein in the table each column is one hop of the respective frequency hopping pattern starting with the second hop. This frequency hopping pattern is already specified for coherent hopping patterns SMK by the ETSI TS103 357 V1.1.1 (2018 June) standard. Due to the use of a uniform frequency hopping pattern, the different time hopping patterns SM and SMK are as orthogonal as possible to each other. This results in less overlap of the radio bursts of a hopping pattern (time hopping pattern) according to the invention with radio bursts of the time hopping pattern in the ETSI TS103 357 V1.1.1 (2018 June) standard. This results in fewer disruptions.

The receiver 20 can determine and/or store the frequency of occurrence or reception of the respective hopping pattern SM or SMK, and adapt its search behavior based on the determined frequency of the respective hopping pattern SM or SMK.

It can also be provided that the transmitter 10 in the uplink transmits an energy buffer-relevant message to the receiver 20, whereupon the receiver 20 defines the search according to the respective type of the hopping pattern SM or SMK. For example, the message may contain information to the effect that the relevant radio node, e.g. FK1, has an energy buffer 13 which is not as powerful. The receiver 20 then directs its search to a non-time-coherent hopping pattern SM.

Non-time-coherent hopping patterns SM can also be formed without clusters instead of forming clusters, in which case all radio bursts of the core frame can have an identical time interval between them.

The time interval T_RB between two adjacent radio bursts is preferably in a range from 0.567 s to 0.757 s. The duration of the core frame in a time-coherent hopping pattern SM is preferably in a range from 14.96 s to 15.32 s. In these ranges, a readjustment can be successfully carried out in the receiver.

The described properties of the method according to the invention relate to the communication between radio node FK1-FK1+n and a receiver 20 in the uplink (UL) and exclusively to the radio bursts of the core frame CF.

The present invention makes it possible to use non-time-coherent hopping patterns SM in a radio network of the TS (telegram splitting) narrowband family. This enables the use of cheaper energy buffers 13. For this reason, production costs can be reduced while maintaining the communication capability of the radio nodes with the receiver in the uplink. The invention therefore constitutes a substantial contribution to the relevant field of technology.

The following is a summary list of reference numerals and the corresponding structure used in the above description of the invention:
FK1, FK1+n nodes
9 radio transmission
10 transmitter
11 data transmission means
12 battery
13 energy buffer
14 microprocessor
15 memory
16 quartz crystal (time)
17 antenna
18 internal resistance
20 receiver
30 headend
100 near-range radio network
CF core frame
EF extension frame
CL1-CL8 cluster
C1-C1+m sub-data packet of the core frame
FB1-FB24 radio bursts of the core frame
T_RB time interval between two radio bursts of the core frame
PS pilot sequence
CRB transmit frequency
B1-B3 block
SM non-time-coherent hopping pattern
SM time-coherent hopping pattern

1. A method for operating a radio network having at least one radio node and at least one radio receiver, which comprises the steps of:
splitting a message in a form of a data packet, via a telegram splitting method, into individual sub-data packets by a transmitter of the at least one radio node in an uplink and the individual sub-data packets are each sent successively in the uplink as a radio burst in a hopping pattern to the at least one radio receiver, the individual sub-data packets of the hopping pattern being those of a frame, each of the individual sub-data packets containing a pilot sequence, and the hopping pattern being a time hopping pattern and/or frequency hopping pattern, wherein the hopping pattern is configured such that the frame or a total number of radio bursts of the frame is greater than coherence time; and
readjusting, in the at least one receiver, a frequency and/or time of radio bursts of the frame on a basis of frequency and/or time hypotheses.

2. The method according to claim 1, which further comprises using only a subset of a total set of possible frequency and/or time shifts for the readjusting step.

3. The method according to claim 2, which further comprises deriving the frequency and/or time hypotheses on a rising and/or falling frequency of a time crystal or a frequency crystal of the at least one radio node.

4. The method according to claim 1, which further comprises only readjusting a subset of a total set of radio bursts of the frame with respect to the frequency and/or time.

5. The method according to claim 1, which further comprises dividing a total set of radio bursts of the frame into three blocks, and carrying out a readjustment with respect to the frequency and/or the time of at least one of the three blocks.

6. The method according to claim 5, wherein:
to readjust the time for one of the blocks, a no shift, a shift by +T/x or a shift by −T/x is carried out, where T is a symbol duration and x is an integer natural number; and/or
to readjust the frequency for one of the blocks (B1-B3), the no shift, an increase in a frequency +yF or a reduction in a frequency −yF is carried out, where F is a frequency and y is an integer natural number.

7. The method according to claim 5, wherein:
to readjust the time, a first block of the blocks is not shifted, a second block of the blocks is shifted by +T/x or −T/x, and a third block of the blocks is shifted by +T/x or −T/x, where T is a symbol duration and x is an integer natural number; and/or
to readjust the frequency, the frequency of the first block is not shifted, for the second block the frequency is shifted by +yF or −yF, and for the third block the frequency is shifted by +yF or −yF, where F is the frequency and y is an integer natural number.

8. The method according to claim 5, wherein an amount of readjustment as a time shift of a block of the blocks relative to a subsequent block of the blocks is between 0 and T/4, where T is a symbol duration, and/or an amount of readjustment as a frequency shift between two subsequent blocks of the blocks is between 0 and 10 Hz.

9. A method for operating a radio network having at least one radio node and at least one receiver, the method comprises the steps of:
splitting a message in a form of a data packet, in a telegram splitting method, into individual sub-data packets by a transmitter of the at least one radio node in an uplink and the individual sub-data packets are each sent successively in the uplink as a radio burst in a hopping pattern to the at least one radio receiver, wherein:
the individual sub-data packets of the hopping pattern being those of a frame;
each of the individual sub-data packets containing a pilot sequence;
the hopping patterns being time hopping patterns and/or frequency hopping patterns;
the hopping pattern is configured such that the frame or a total number of radio bursts of the frame is greater than a coherence time, wherein:
a total number of 24 said radio bursts of the frame in the hopping pattern and three said radio bursts each form a cluster, a time interval between the radio bursts of the cluster being dimensioned such that the frame or the total number of radio bursts of the frame is greater than the coherence time; or
no clusters are formed and the time interval between the radio bursts is dimensioned such that the frame or the total number of radio bursts of the frame is greater than the coherence time.

10. The method according to claim 9, which further comprises:
setting a size of the time interval between a first and second radio burst of each said cluster is in a range of 1483 symbol lengths±20%; and/or
setting a size of the time interval between the second radio burst and a third radio burst of each said cluster in a range of 1683 symbol lengths±20%.

11. A method for operating a radio network having at least one radio node and at least one receiver, the method comprises the steps of:
splitting a message in a form of a data packet, in a telegram splitting method, into individual sub-data packets by a transmitter of the at least one radio node in an uplink and the individual sub-data packets are each sent successively in the uplink as a radio burst in a hopping pattern to the at least one radio receiver, wherein:

| SM | T_{RB}(s) | | | | | | | | | | | |
|---|---|---|---|---|---|---|---|---|---|---|---|---|
| no. | 1 | 2 | 3 | 4 | 5 | 6 | 7 | 8 | 9 | 10 | 11 | 12 |
| 1 | 1483 | 1683 | 1670 | 1483 | 1683 | 1446 | 1483 | 1683 | 1744 | 1483 | 1683 | 1644 |
| 2 | 1483 | 1683 | 1659 | 1483 | 1683 | 1681 | 1483 | 1683 | 1745 | 1483 | 1683 | 1464 |
| 3 | 1483 | 1683 | 1604 | 1483 | 1683 | 1756 | 1483 | 1683 | 1782 | 1483 | 1683 | 1697 |
| 4 | 1483 | 1683 | 1734 | 1483 | 1683 | 1519 | 1483 | 1683 | 1403 | 1483 | 1683 | 1397 |
| 5 | 1483 | 1683 | 1803 | 1483 | 1683 | 1473 | 1483 | 1683 | 1796 | 1483 | 1683 | 1464 |
| 6 | 1483 | 1683 | 1481 | 1483 | 1683 | 1528 | 1483 | 1683 | 1582 | 1483 | 1683 | 1511 |
| 7 | 1483 | 1683 | 1524 | 1483 | 1683 | 1555 | 1483 | 1683 | 1481 | 1483 | 1683 | 1350 |
| 8 | 1483 | 1683 | 1358 | 1483 | 1683 | 1546 | 1483 | 1683 | 1379 | 1483 | 1683 | 1680 |
| SM | T_{RB}(s) | | | | | | | | | | |
|---|---|---|---|---|---|---|---|---|---|---|---|
| no. | 13 | 14 | 15 | 16 | 17 | 18 | 19 | 20 | 21 | 22 | 23 |
| 1 | 1483 | 1683 | 1409 | 1483 | 1683 | 1444 | 1483 | 1683 | 1634 | 1483 | 1683 |
| 2 | 1483 | 1683 | 1753 | 1483 | 1683 | 1368 | 1483 | 1683 | 1439 | 1483 | 1683 |
| 3 | 1483 | 1683 | 1441 | 1483 | 1683 | 1450 | 1483 | 1683 | 1349 | 1483 | 1683 |
| 4 | 1483 | 1683 | 1571 | 1483 | 1683 | 1539 | 1483 | 1683 | 1350 | 1483 | 1683 |
| 5 | 1483 | 1683 | 1399 | 1483 | 1683 | 1491 | 1483 | 1683 | 1372 | 1483 | 1683 |
| 6 | 1483 | 1683 | 1645 | 1483 | 1683 | 1677 | 1483 | 1683 | 1605 | 1483 | 1683 |
| 7 | 1483 | 1683 | 1389 | 1483 | 1683 | 1754 | 1483 | 1683 | 1762 | 1483 | 1683 |
| 8 | 1483 | 1683 | 1427 | 1483 | 1683 | 1476 | 1483 | 1683 | 1404 | 1483 | 1683 |

each of the time hopping patterns comprises 23 hops; and
each entry in the table indicates a time interval T_RB(s) between a reference point of a respective said radio burst and an identical reference point of a directly following radio burst in symbols, and wherein in the table, each row of rows 1-8 is said time hopping pattern.

12. The method according to claim 11, wherein each of the symbols contains a symbol duration of 1/(K*2380.371), where K is an integer number.

13. The method according to claim 11, wherein the hopping patterns include the frequency hopping patterns as defined by the following table:

| SM | C_{RB}(s) | | | | | | | | | | | | |
|---|---|---|---|---|---|---|---|---|---|---|---|---|---|
| no. | 0 | 1 | 2 | 3 | 4 | 5 | 6 | 7 | 8 | 9 | 10 | 11 | 12 |
| 1 | 5 | 21 | 13 | 6 | 22 | 14 | 1 | 17 | 9 | 0 | 16 | 8 | 7 |
| 2 | 4 | 20 | 12 | 1 | 17 | 9 | 0 | 16 | 8 | 6 | 22 | 14 | 7 |
| 3 | 4 | 20 | 12 | 3 | 19 | 11 | 6 | 22 | 14 | 7 | 23 | 15 | 0 |
| 4 | 6 | 22 | 14 | 2 | 18 | 10 | 7 | 23 | 15 | 0 | 16 | 8 | 1 |
| 5 | 7 | 23 | 15 | 4 | 20 | 12 | 3 | 19 | 11 | 2 | 18 | 10 | 6 |
| 6 | 3 | 19 | 11 | 6 | 22 | 14 | 2 | 18 | 10 | 0 | 16 | 8 | 7 |
| 7 | 3 | 19 | 11 | 1 | 17 | 9 | 5 | 21 | 13 | 7 | 23 | 15 | 0 |
| 8 | 0 | 16 | 8 | 6 | 22 | 14 | 3 | 19 | 11 | 2 | 18 | 10 | 4 |
| SM | C_{RB}(s) | | | | | | | | | | |
|---|---|---|---|---|---|---|---|---|---|---|---|
| no. | 13 | 14 | 15 | 16 | 17 | 18 | 19 | 20 | 21 | 22 | 23 |
| 1 | 23 | 15 | 4 | 20 | 12 | 3 | 19 | 11 | 2 | 18 | 10 |
| 2 | 23 | 15 | 2 | 18 | 10 | 5 | 21 | 13 | 3 | 19 | 11 |
| 3 | 16 | 8 | 5 | 21 | 13 | 2 | 18 | 10 | 1 | 17 | 9 |
| 4 | 17 | 9 | 4 | 20 | 12 | 5 | 21 | 13 | 3 | 19 | 11 |
| 5 | 22 | 14 | 0 | 16 | 8 | 1 | 17 | 9 | 5 | 21 | 13 |
| 6 | 23 | 15 | 1 | 17 | 9 | 4 | 20 | 12 | 5 | 21 | 13 |
| 7 | 16 | 8 | 2 | 18 | 10 | 6 | 22 | 14 | 4 | 20 | 12 |
| 8 | 20 | 12 | 7 | 23 | 15 | 5 | 21 | 13 | 1 | 17 | 9 |

wherein each of the frequency hopping patterns contains 24 frequency channels;
wherein each entry in the table is a transmit frequency CRB(s) or a frequency channel of the frequency hopping pattern; and
wherein in the table, each row of rows 1-8 is the frequency hopping pattern.

14. A method for operating a radio network having at least one radio node and at least one receiver, the method comprises the steps of:
splitting a message in a form of a data packet, in a telegram splitting method, into individual sub-data packets by a transmitter of the at least one radio node in an uplink and the individual sub-data packets are each sent successively in the uplink as a radio burst in a hopping pattern to the at least one radio receiver, wherein:
the individual sub-data packets of the hopping pattern being those of a frame;
each of the individual sub-data packets contains a pilot sequence;
the hopping patterns being time hopping patterns and/or frequency hopping patterns; and
the hopping pattern is configured such that the frame or a total number of radio bursts of the frame is greater than a coherence time, wherein:
the radio bursts of the frame have an identical time interval between one another; and/or
the time interval between two adjacent said radio bursts is in a range from 0.567 s to 0.757 s; and/or
a duration of the frame is in a range from 14.96 s to 15.32 s.

15. The method according to claim 14, wherein the at least one receiver searches for:
a hopping pattern, of which the frame or the total number of radio bursts of the frame is greater than the coherence time; and
a hopping pattern, of which the frame or the total number of radio bursts of the frame is within the coherence time.

16. The method according to claim 15, wherein the at least one receiver determines a frequency of reception of a respective said hopping pattern.

17. The method according to claim 16, wherein the at least one receiver adapts its search behavior based on a determined frequency of the respective hopping pattern.

18. The method according to claim 14, wherein the transmitter in the uplink transmits an energy buffer-relevant message to the at least one receiver, whereupon the at least one receiver defines a search for the hopping pattern.

19. A transmitter for operating a radio network, wherein the transmitter is configured to be operated according to the method according to claim 1.

20. A receiver for operating a radio network, wherein the receiver is configured to be operated according to the method according to claim 1.
